(19) United States
(12) Patent Application Publication
(10) Pub. No.: US 2007/0275194 A1
(43) Pub. Date: Nov. 29, 2007

(54) Slidingly Detachable Core Member and Cold Shrink Tube Unit Having the Same

(76) Inventors: Shigeru Suzuki, Sagamihara (JP); Massao Ohtsubo, Tokyo (JP)

Correspondence Address: 3M INNOVATIVE PROPERTIES COMPANY, PO BOX 33427, ST. PAUL, MN, 55133-3427, US

(21) Appl. No.: 10/596,737

(22) PCT Filed: Dec. 17, 2004
(86) PCT No.: PCT/US04/42364

§ 371 Date: Apr. 16, 2007

(30) Foreign Application Priority Data
Dec. 24, 2003 (JP) 2003-427682

(51) Int. Cl. B32B 1/08; B29D 22/00

(52) U.S. Cl. 428/34.9; 428/34.1

(57) ABSTRACT

A slidingly detachable core member (12) for use within an elastic tube (16) is provided. The core member (12) has a hollow cylindrical body (22) and a sliding material (24) associated with the body. An extension (26) is provided in the body (22) and extends outward.

### TECHNICAL FIELD

The present invention relates to a slidingly detachable core member for use within an elastic tube. Moreover, the present invention relates to a cold shrink tube unit including a slidingly detachable core member.

### BACKGROUND ART

A cold shrink tube unit including an elastic tube member having an opening end, and a hollow cylindrical core member detachably arranged within a region (referred to as a seal region in this specification) of the elastic tube member defined in a predetermined length from the opening end to hold the seal region in an elastically expanding state, has been adopted in various fields as a covering unit capable of being quickly attached to an object. For example, a cold shrink covering tube is used to sheath an electric wire bared from a joint between cables (sheathed electric wires) or a joint between a cable and other conductive terminal member for the purpose of moisture-proofing, electric isolation, or mechanical protection. Specifically, a seal region of an elastomeric tube member whose length exceeds the whole length of the joint is held in advance with the diameter thereof elastically expanded using a hollow cylindrical plastic core member. When the seal region is attached to the joint, the core member is removed so that the seal region will contract and brought into close contact with the outer peripheral surface of the cable.

As the core member employed in the foregoing cold shrink tube unit, a member having a helically continuous groove, that is, a weakening line formed over the whole length of a hollow cylindrical body in an axial direction thereof is known. The body of the core member can be torn apart along the groove like ribbons using the end of the groove located at one end of the body in the axial direction thereof as a tear start end. As the tearing detachable type core member, a core member whose cylindrical core body is made by helically winding elongated plastic ribbons and joining the adjoining edges ribbons so that the joined edges will form helical grooves has been proposed. A core member whose plastic core body is molded like a hollow cylinder and has helical cutouts formed therein has also been proposed.

Moreover, a core member having a sliding member interposed between a hollow cylindrical core body and a seal region of an elastic tube member is also known. Specifically, owing to the operation of the sliding member of facilitating sliding, the core body can be readily pulled out of the seal region in the axial direction thereof. The slidingly detachable core member may have the sliding member independent of the hollow cylindrical core body. After the core body is pulled out, the sliding member may be left in the seal region (see, for example, Patent Document 1). Otherwise, the sliding member may be independent of the hollow cylindrical core body, and removed when the core body is pulled out (see, for example, Patent Document 2). Otherwise, the sliding member may be coupled to one end of the hollow cylindrical core body in the axial direction thereof as an integral part of the core body. The sliding member may include a sliding portion that is so flexible as to be folded and placed on the outer peripheral surface of the core body (see, for example, Patent Documents 1 and 3).

The various cold shrink tube units have significant differences in the workability in detaching the core member from the seal region of the elastic tube member when the elastic tube member is attached to an object of covering (for example, a joint of electric wires). This is attributable to differences in the structure of the core member. More particularly, as far as the cold shrink tube unit having the tearing detachable core member is concerned, when the core member is detached, the ribbon-like sections into which the core body is torn apart along the helical grooves tend to entwine the object of covering while maintaining the helical state. The body must therefore be torn apart while separating the entwining ribbon-like sections from each other. Consequently, the longer the length of the seal region of the elastic tube member, that is, the longer the whole length of the core member in the axial direction thereof, the time and labor may be consumed for detachment of the core member. In contrast, as far as the cold shrink tube unit having the slidingly detachable core member is concerned, when the core member is detached, the core body can be pulled out of the seal region of the elastic-tube member linearly in the axial direction. Consequently, the entwinement of the ribbon-like sections around the object of covering is avoided, and the time and labor required for detachment are reduced. Moreover, after the tearing detachable core member is detached, it is torn apart into ribbon-like sections and cannot be reused any longer. In contrast, the detached core body of the slidingly detachable core member can be normally reused. This contributes to reduction in the cost of materials and encourages energy saving.

[Patent Document 1] Japanese Unexamined Patent Publication (Kokai) No. 7-123561

[Patent Document 2] Japanese Unexamined Patent Publication (Kokai) No. 11-218267

[Patent Document 3] Japanese Unexamined Patent Publication (Kokai) No. 9-254261

### DISCLOSURE OF THE INVENTION

### Problems to be Solved by the Invention

In conventional cold shrink tube units, generally, a core member is inserted in a seal region of an elastic tube member with a cylindrical part of a core body, which has any length from one end of the core body in the axial direction thereof, projecting outward of the opening end of the elastic tube member. Therefore, even in the cold shrink tube unit having the conventional slidingly detachable core member, when the core member is detached from the seal region of the elastic tube member, external force (normally, tensile force) required to detach the core body from the seal region can be applied to the projecting cylindrical part of the core body. However, this structure has a drawback described below. For example, assume that a remotely controlled instrument such as a magic hand is used to detach the core member for fear of an electric shock that may occur during the work of attaching the cold shrink tube unit to a joint of electric wires that are conducting (active). In this case, depending on a working condition, it may be hard to efficiently apply the external force to the core body for the purpose of detachment.

The aforesaid Patent Document 2 has disclosed a structure in which a film-like sliding member is interposed between the seal region of an elastic tube member and the outer peripheral surface of a core body. Specifically, the sliding member has a string-like pullout portion that lies through the core body and extends out of the elastic tube member. Thus, the sliding member is formed as a pullout film to be used to detach the core member. However, according to this structure, the external force required to detach the core body from the seal region is applied directly to the sliding member that is the pullout film. In order to improve the reliability in the work of detaching the core, the sliding member must be mechanically strong enough. On the other hand, the film-like sliding member employed in the structure is turned over and placed on the external and internal surfaces of the core body so that it will encase the end of the core body in the axial direction thereof within the elastic tube member. The film-like sliding member moves so that the turnover portion thereof will be displaced continuously along with the pullout of the core body. Consequently, when the mechanical strength of the sliding member is intensified, the smoothness in turning over and displacing the sliding member during detachment of the core member is impaired. Consequently, the external force required to detach the core body increases. Eventually, the sliding member may be damaged, and the reliability in the work of detaching the core member may be degraded.

In one aspect, the present invention provides a slidingly detachable core member to be used while being inserted in an elastic tube such as an elastic tube member included in a cold shrink tube unit. The external force required to detach a core body from the elastic tube can be efficiently transmitted, and the work of detaching the core member can be achieved quickly on a stable basis with high reliability.

In another aspect, the present invention provides a cold shrink tube unit having a slidingly detachable core member and offering the improved workability in attaching the cold shrink tube unit to an object of covering.

In yet another aspect, the present invention provides a slidingly detachable core member for use within an elastic tube. The core member comprises a hollow cylindrical body and a sliding material associated with the body for reducing friction between the body and an elastic tube encompassing the body, characterized in that an extension is provided in the body and extends outward, to transmit external force, for detachment of the body from the elastic tube, to the body.

According to the invention as set forth in claim 1, external force required to detach a slidingly detachable core member from an elastic tube can be efficiently applied directly to the body via an extension of a body. At this time, the mechanical strength of the extension needed to withstand detaching force is given by the extension itself and a region coupling the extension and body. Consequently, the external force required to detach the body from the elastic tube is efficiently transmitted to the body. This helps quickly detach the core member on a stable basis with high reliability.

According to the invention as set forth in claim 2, compared with a structure in which a lubricant is employed as a sliding member, it is quite easy to handle the sliding member.

According to the invention as set forth in claim 3, an optimal material that exhibits a required sliding property and a required smoothly moving property during detachment of a core member is selected and adopted.

According to the invention as set forth in claim 4, a sliding member can be disposed accurately in a working region on the outer peripheral surface of a body, and the sliding member can exhibit the self-sliding property during detachment of a core.

According to the invention as set forth in claim 5, an elastic tube and a body can locally be brought into close contact with each other through a cutout formed in a molded film serving as a sliding member. Consequently, a slidingly detachable core member can be prevented from spontaneously coming off from the elastic tube because of the self-sliding property of the sliding member.

According to the invention as set forth in claim 6, after a slidingly detachable core member is detached from an elastic tube, a body can be handled easily.

According to the invention as set forth in claim 7, when a cold shrink tube unit is attached to an object of covering, even if a core member must be detached outdoor using a remotely controlled instrument, external force required for detachment can be efficiently applied to the body of the core member. Consequently, the workability in attaching the cold shrink tube unit to the object of covering markedly improves.

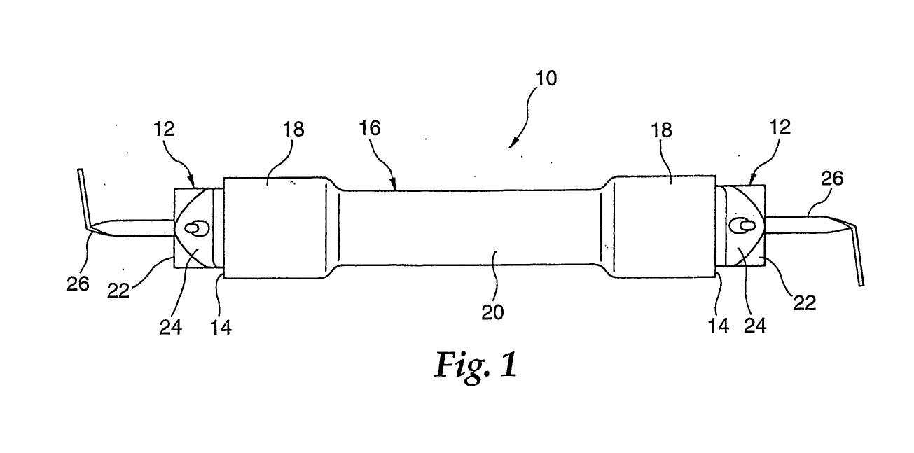

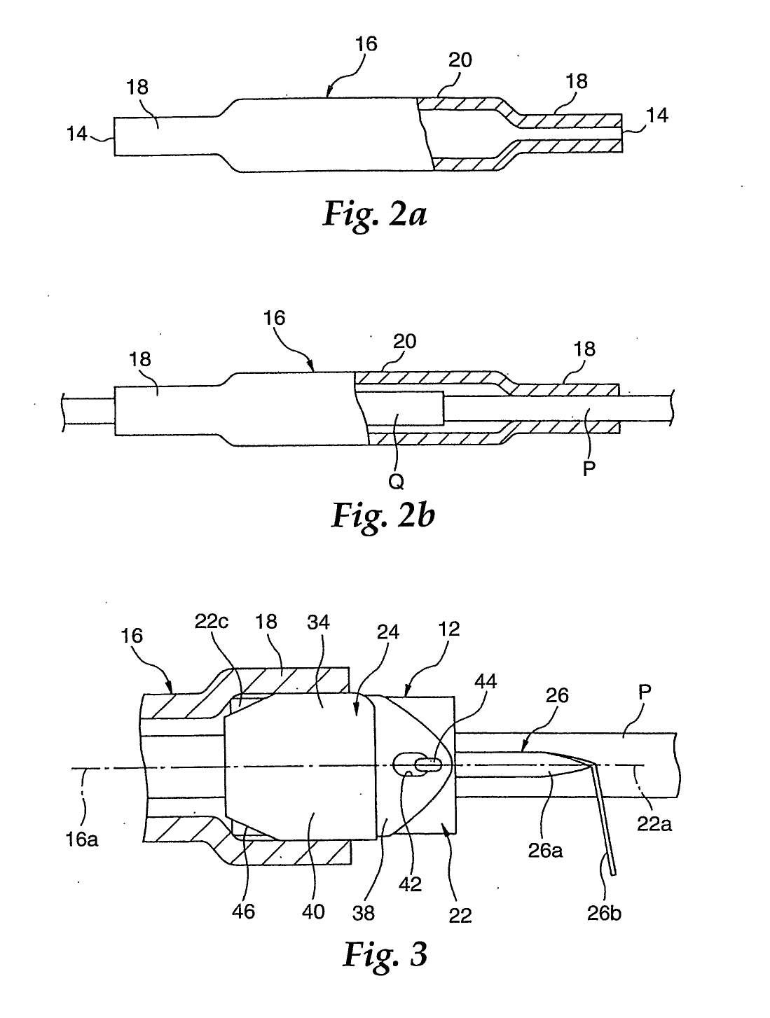

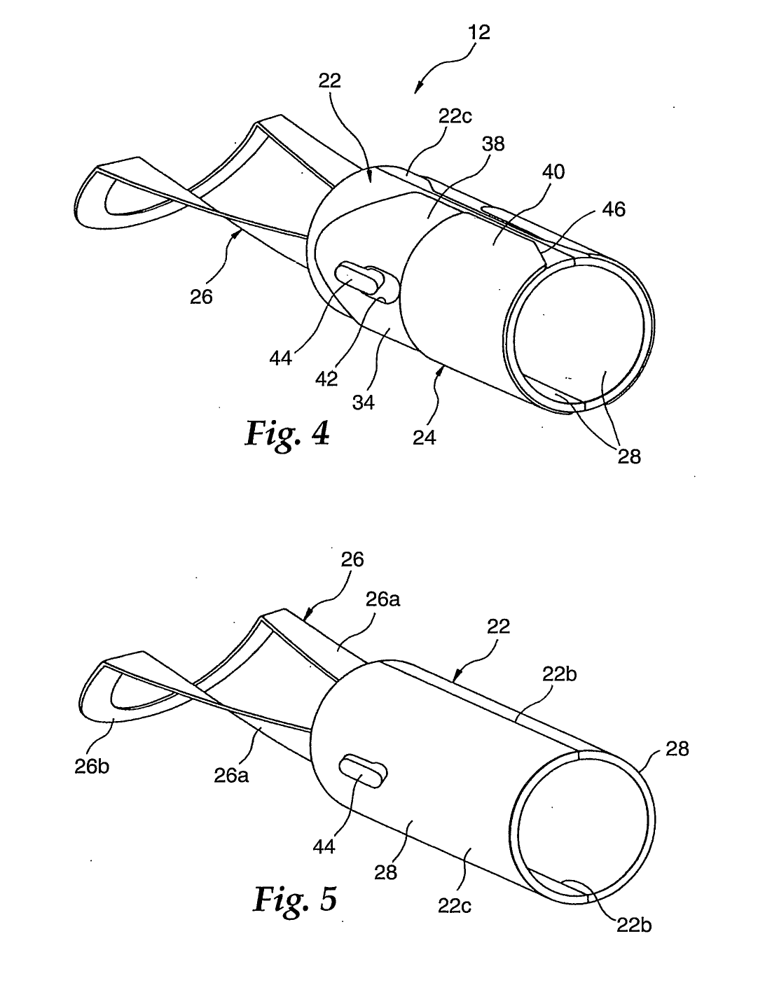

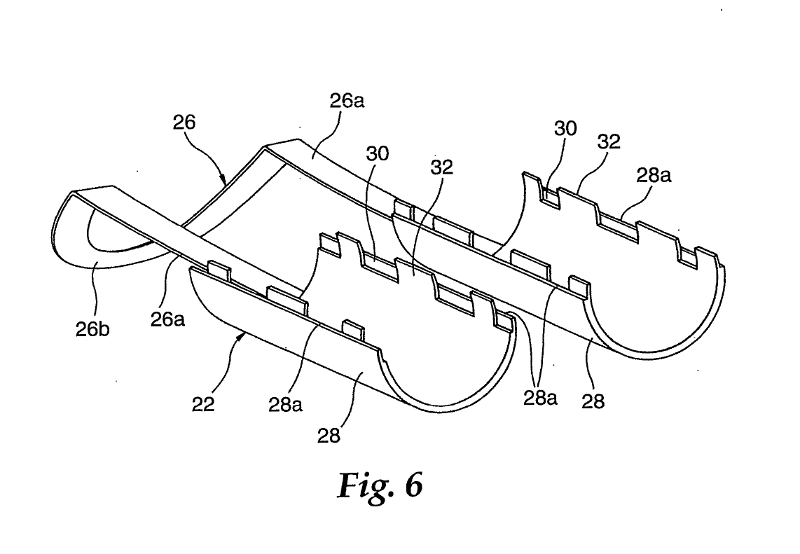

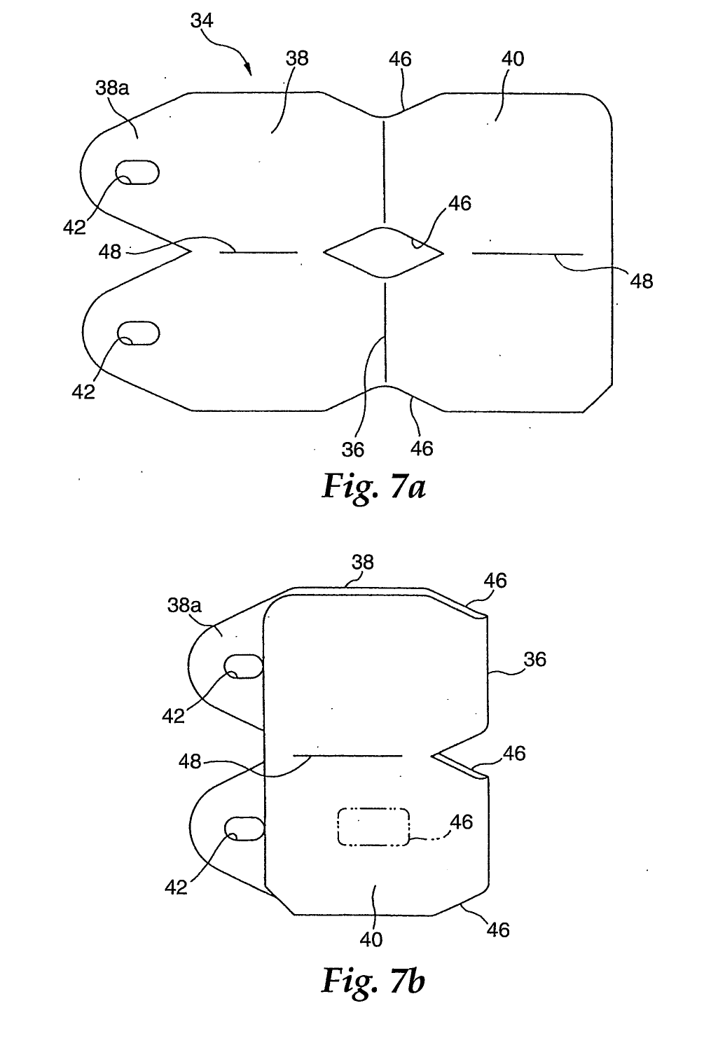

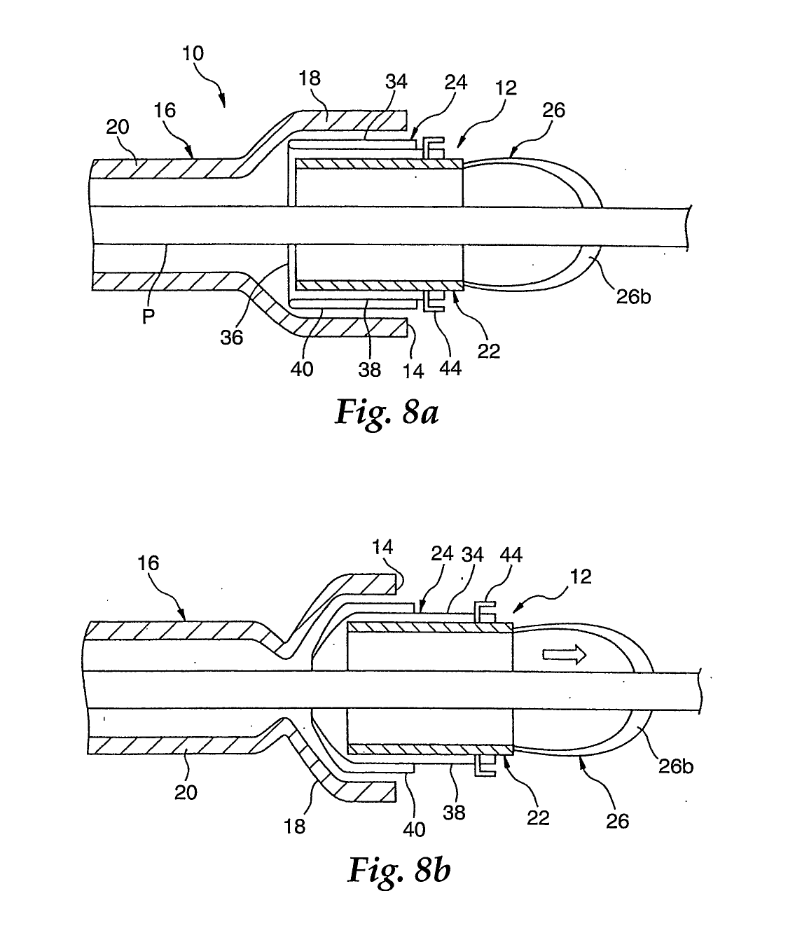

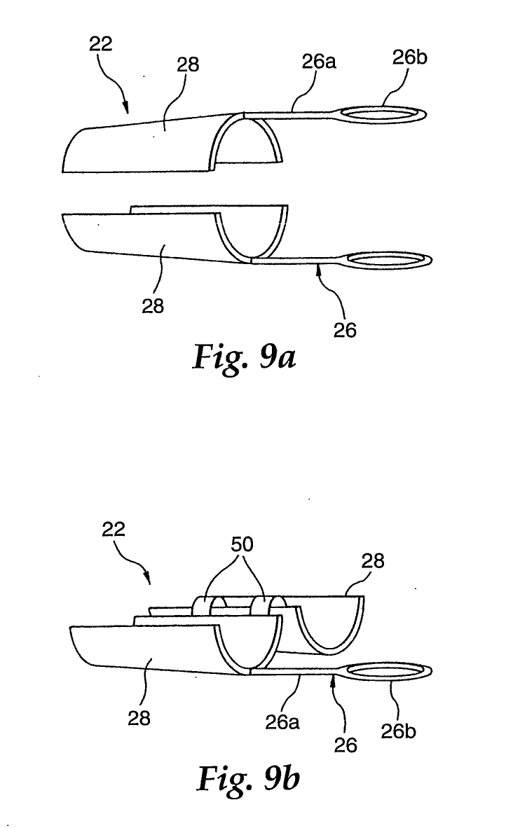

### BRIEF DESCRIPTION OF THE DRAWINGS

[FIG. 1] A front view of a cold shrink tube unit in accordance with one exemplary embodiment of the present invention.

[FIG. 2] An illustration of an elastic tube member included in the cold shrink tube unit shown in FIG. 1, (a) is a front cutaway, and (b) is a front cutaway showing the elastic tube member attached to an object of covering.

[FIG. 3] A cutaway view showing a seal region of the elastic tube member included in the cold shrink tube unit shown in FIG. 1.

[FIG. 4] A perspective view showing a core member employed in the cold shrink tube unit in accordance with the embodiment of the present invention shown in FIG. 1.

[FIG. 5] A perspective view showing a body of the core member shown in FIG. 4.

[FIG. 6] A perspective view showing the body shown in FIG. 5 in an exploded manner.

[FIG. 7] An illustration of a sliding member included in the core member shown in FIG. 4, (a) is a plan view showing the sliding member developed, and (b) is a plan view showing the sliding member folded in two.

[FIG. 8] A pattern diagram for explaining the work of detaching the core member included in the cold shrink tube unit shown in FIG. 1, (a) shows the cold shrink tube unit with the core member not detached, and (b) shows the cold shrink tube unit with the core member being detached.

[FIG. 9] (a) shows a body of a core member employed in a variant, and (b) shows a body employed in other variant.

Referring to appended drawings, an embodiment of the present invention will be described below. Common reference numerals will be assigned to components shown in the drawings.

With reference to FIGS. 1 to 4, the cold shrink tube unit 10 has a linear tube having two opening ends and uses as a cold shrink type covering tube that sheathes and protects a linear joint of, for example, cables (sheathed electric wires). However, the usage of the cold shrink tube unit 10 is not limited to this one. Moreover, the core member 12 is a slidingly detachable core member usable while being inserted in various elastic tube members.

The cold shrink tube unit 10 includes a hollow cylindrical elastic tube member 16 having opening ends 14 as both ends thereof in the longitudinal direction thereof; and a pair of hollow cylindrical core members 12 that are inserted in seal regions 18, which have a predetermined length from the respective opening ends 14 of the elastic tube member 16, so that they can be removed, and that hold the seal regions 18 while elastically expanding the diameters thereof (FIG. 1). The elastic tube member 16 has an intermediate region 20 joined concentrically to the seal regions 18 as a united body. When the elastic tube member 16 is unloaded with the core member 12 not inserted therein, the inner diameter of the seal regions 18 is smaller than the inner diameter of the intermediate region 20 (FIG. 2(a)). Consequently, when the core members 12 are removed from the cold shrink tube unit 10, the elastic tube member 16 is brought into contact with an object of covering (for example, a cable) P. At this time, the elastic tube member 16 is brought into close contact with the outer peripheral surface of the object P under application of elastically restoring force. The intermediate region 20 sheathes a required portion (for example, an electric joint) of the object P for the purpose of moisture-proofing, electric insulation, or mechanical protection (FIG. 2(b)).

The elastic tube member 16 is made of an elastomer having an electrically insulating property and flexibility by nature. The seal regions 18 and intermediate region 20 are made of, preferably, the same material and formed as an united body through injection molding or extrusion molding (or thermoforming, blowforming, etc.). Materials to be made into the elastic tube member 16 are preferably ethylene propylene rubber (especially EPDM), chloroprene rubber, butyl rubber, silicone rubber, natural rubber, fluorocarbon rubber, silicone modified EPDM, and others. In particular, when the cold shrink tube unit 10 is used as a covering tube for covering an electric joint, at least the seal regions 18 of the elastic tube member 16 should exhibit a permanent elongation of, preferably, 40% or less, or more preferably, of 15% or less when measured according to a method conformable to the JIS: K6249 (100° C. for 22 hours).

Each of the core members 12 has a hollow cylindrical body 22, and inserted in the seal region 18 with the center-axis line 22a of the body 22 thereof aligned with the center-axis line 16a of the elastic tube member 16 (FIG. 3). The body 22 of the core member 12 has an inner diameter much larger than the outer diameter of the object of covering P to which the cold shrink tube unit 10 is adapted. The body 22 of the core member 12 is rigid enough to withstand elastically restoring force exerted by the seal region 18 of the elastic tube member 16 and to hold the seal region 18 while expanding the diameter of the seal region 18 to a predetermined diameter.

The core member 12 employed in the embodiment of the present invention is of a slidingly detachable type. The core member 12 includes the hollow body 22; a sliding material 24 included in relation to the body 22 in order to reduce the friction between the body 22 and the seal region 18 of the elastic tube member 16 which encompasses the body 22; and an extension 26 that extends out of the body 22 and that transmits external force, which is required to detach the body 22 from the seal region 18, to the body 22 (FIG. 4). The core member 12 is inserted in the associated seal region 18 with the extension 26 thereof projecting outward of the opening end 14 of the elastic tube member 16 (FIG. 1).

As shown in FIG. 5, the body 22 of the core member 12 has a plurality of plate-like elements 28 that is assembled to form a hollow cylindrical body. In the illustrated embodiment, the body 22 has a pair of plate-like elements 28, each of which has a bow-shaped section that is a half of a section of a hollow cylinder, joined along division lines 22b parallel to the center-axis line 22a. Each of the plate-like elements 28 has a pair of engagement surfaces 28a (see FIG. 6) that can be engaged with the equivalent surfaces of the other plate-like element 28. Each of the plate-like elements 28 is engaged with the other plate-like element with the engagement surfaces 28a brought into close contact with the equivalent engagement surfaces 28a of the other plate-like element 28. Consequently, the pair of plate-like elements 28 constitutes the body 22 that is rigid enough to hold the hollow cylindrical form while withstanding expected external force. The divisible structure of the body 22 helps readily removing the body 22 of the core member 12, which becomes unnecessary after the cold shrink tube unit 10 (elastic tube member 16) is attached to the object of covering P with the core member 12 removed, from the object of covering P.

The body 22 has pluralities of concave parts 30 and convex parts 32, which are complementarily meshed with one another, formed on the two pairs (or at least one pair) of engagement surfaces 28a of the pair of plate-like elements 28 which are engaged with each other (FIG. 6). The concave parts 30 and convex parts 32 act as alignment elements that assist in assembling the pair of plate-like elements 28 in place, and also act as reinforcement pieces that maintain the plate-like elements 28 in the form of a hollow cylinder. The concave parts 30 and convex parts 32 are molded as integral parts of the plate-like elements 28 of the body 22 in the molding process of the core member 12. Incidentally, the concave parts 30 and convex part 32 are formed by alternately creating a thinned part and an intact part near the engagement surfaces 28 of the plate-like members 28. There is the merit that the thickness of the plate-like elements 28 need not be increased due to the complementary engagement structure.

As shown in FIGS. 5 and 6, the extension 26 of the core member 12 is formed with one belt-like element that extends from the pair of plate-like elements 28 at one end of the body 22 in the axial direction thereof and that has flexibility itself. The extension 26 includes a pair of arm portions 26a that is coupled to the respective plate-like elements 28 as integral parts thereof and that serves as both sides of the extension having a desired length; and an arc portion 26b that is coupled to the arm portions 26a as integral parts thereof and that serves as the center of the extension having a desired length. When the pair of plate-like elements 28 is assembled properly to construct the body 22, the arm portions 26a of the extension 26 are extended substantially parallel to the center-axis line 22a of the body 22. The arc portion 26b is extended in a direction crossing the center-axis line 22a. Owing to the shape of the extension 26, when the cold shrink tube unit 10 is attached to the object of covering P, interference between the extension 26 of the core member 12 inserted in the elastic tube member 16 and the object P is avoided owing to the arc portion 26b. Moreover, in the work of detaching the core member to be described later, external force (tensile force in the present embodiment) required to detach the body 22 of the core member 12 from the seal region 18 is efficiently transmitted to the body 22 of the core member 12 by way of the arc portion 26b and the arm portions 26a.

Furthermore, the extension 26 of the core member 12 has the capability to join the pair of plate-like elements 28, which constitute the body 22, so that the plate-like elements can be displaced relative to each other. In other words, the extension 26 having flexibility itself acts as a hinge to prevent the plate-like elements 28 from being separated from each other irrespective of whether the body 22 is brought to an operable position with the pair of plate-like elements 28 assembled (FIG. 5) or the body 22 is brought to a non-operable position with the pair of plate-like elements 28 separated from each other (FIG. 6). After the core member 12 is detached from the seal region 18 of the elastic tube member 16, the body 22 that is removed from the object of covering P while being broken into halves and that is unnecessary can be handled easily. Moreover, because a hinge need not be molded separately from the extension 26, the structure of a die needed to mold the core body 22 is simplified.

The body 22 and extension 26 of the core member 12 are made of any resin material that exhibits superb mechanical strength, such as, polypropylene (PP), polyethylene (PE), polyethylene terephthalate (PET), polytetrafluoroethylene (PTFE), polyvinyl chloride (PVC), polyamide, or polyimide, and molded as a united body through, preferably, injection molding or any other molding. During the molding process, the plate-like elements 28 and extension 26 of the body 22 are molded as a united body using the same resin material. Otherwise, the plate-like elements 28 and extension 26 of the body 22 that are molded using different materials according to different methods may be assembled by adopting such means as welding, bonding, or mechanical coupling.

The sliding material 24 of the core member 12 includes a sheet-like sliding member 34 that is placed on the substantially cylindrical outer peripheral surface 22c of the body 22 composed of the plurality of plate-like elements 28 (FIG. 4). The sliding member 34 is made of a molded film that has a self-sliding property and that is formed separately from the body 22 and attached to the body 22. The molded film forming the sliding member 34 is folded in two on the outer peripheral surface 22c of the body 22 when the body 22 is brought to the operable position while being encompassed in the seal region 18 of the elastic tube member 16. Moreover, the molded film substantially covers the working region on the outer peripheral surface 22c of the body 22 encompassed in the seal region 18 (FIG. 3 and FIG. 4).

Referring to FIG. 7, the sliding member 34 is cut out, that is, part of the substantially rectangular contour thereof in a plan view is cut off (FIG. 7(a)). The sliding member 34 is mechanically divided with a crease 36 as a border into an internal-layer portion 38 that is placed on the outer peripheral surface 22c of the body 22, and an external-layer portion 40 that is placed on the internal-layer portion 38 (FIG. 7(b)). The internal-layer portion 38 of the sliding member 34 has a slightly larger surface area than the external-layer portion 40 thereof. At least the surface area of the external-layer portion 40 is large enough to substantially cover the working region on the outer peripheral surface 22c of the body 22. The sliding member 34 is designed so that the overlapping internal-layer portion 38 and external-layer portion 40 will exhibit a sliding property and the least frictional resistance (that is, exhibit the property of reducing frictional force).

The internal-layer portion 38 of the sliding member 34 has a projecting region 38a that extends out of the external-layer portion 40 when the sliding member 34 is folded in two. A pair of attachment holes 42 used to attach the sliding member 34 to the body 22 is formed in the projecting region 38a (FIG. 7). The attachment holes 42 receive respective fitting claws 44 that are formed at predetermined positions on the outer peripheral surface 22c of the body 22, whereby the sliding member 34 is locked on the outer peripheral surface 22c of the body 22. In the illustrated embodiment, the fitting claws 44 are formed on the respective plate-like elements 28 constituting the body 22. Moreover, the film material made into the sliding member 34 may be a laminated material in efforts to guarantee the mechanical strength of the portion of the sliding member 34 around the attachment holes 42 when the fitting claws 44 are fitted in the attachment holes. Furthermore, the portion of the sliding member 34 made of the film material, which does not contribute to the mechanical strength of the portion of the sliding member 34 around the attachment holes 42 when the fitting claws 44 are fitted in the attachment holes, is cut away as illustrated.

The molded film made into the sliding member 34 has a plurality of cutouts 46 through which when the sliding member 34 is folded in two and placed on the outer peripheral surface 22c of the body 22, the working region on the outer peripheral surface 22c of the body is exposed locally (FIG. 7). The cutouts 46 are formed, in the present embodiment, substantially in the center of the molded film folded along the crease 36 and on both edges thereof. When the core member 12 is properly inserted in the seal region 18 of the elastic tube member 16, the cutouts 46 permit the outer peripheral surface 22c of the body 22 to locally come into close contact with the internal surface of the seal region 18 (in FIG. 3, a gap is depicted for a better understanding, but, in reality, the outer peripheral surface 22c of the body 22 comes into close contact with the internal surface of the seal region 18 owing to the elastically restoring force of the seal region 18).

As mentioned above, the seal region 18 and body 22 locally come into close contact with each other through the sliding member 34. Consequently, the cold shrink tube unit 10 has overcome such a drawback that when the components are assembled as shown in FIG. 1 prior to use, the body 22 spontaneously comes off from the seal region 18 because of both the elastically restoring force of the seal region 18 and the self-sliding property of the sliding member 34. In this case, during the work of detaching the core member, it is necessary to first apply large external force (tensile force), which is large enough to overwhelm the locally close contact between the seal region 18 and body 22, for the purpose of detaching the core member 12. However, as the body 22 is drawn out of the seal region 18, the cutouts 46 are pulled into the internal-layer portion 38. Therefore, the locally close contact between the seal region 18 and body 22 gradually diminishes and finally disappears. Eventually, the sliding property of the sliding member 34 is fully exhibited, and the core member 12 can be detached with small external force. The cutouts 46 are not limited to the aforesaid ones, but may be formed at various positions at which the overlapping internal-layer portion 38 and external-layer portion 40 are layered (for example, a position indicated with an alternate long and two short dashes line in FIG. 7(b)).

The molded film forming the sliding member 34 has a plurality of slits 48 formed locally at desired positions so that the slits will extend in a direction substantially orthogonal to the crease 36 (FIG. 7). The slits 48 help the external-layer portion 40 to be pulled toward the internal-layer portion 38 as the body 22 is pulled out of the seal region 18 during the work of detaching the core member. Specifically, since the molded film opens or closes at the positions of the slits 48, the pullout can be achieved smoothly. Incidentally, the slits 48 are not limited to the above ones but may be formed at various positions as long as the mechanical strength of the sliding member 34 is not impaired.

The molded film forming the sliding member 34 is made of a resin material that exhibits superb mechanical strength, such as, polyethylene terephthalate (PET), polypropylene (PP), polyethylene (PE), or polyacrylonitrile (PAN). Moreover, even when the molded film is made of any of these resin materials, the contact surfaces of the internal-layer portion 38 and external-layer portion 40 which come into contact with each other when the molded film is folded in two are preferably finished with a coat that gives lubrication, such as, silicone or fluorine. Otherwise, very fine particles such as silica may be sprayed to the contact surfaces. The thickness of the sliding member 34 should be determined so that mechanical strength can be guaranteed but the workability in detaching the core member will not be impaired. The thickness of the sliding member 34 ranges, preferably, from 10 μm to 100 μm, or more preferably, from 40 μm to 60 μm.

In order to construct the cold shrink tube unit 10 having the foregoing components, first, the pair of plate-like elements 28 is assembled in order to form the body 22. The sliding member 34 folded in two (FIG. 7(b)) is then placed on the outer peripheral surface 22c of the body 22 by fitting the fitting claws 44 into the pair of attachment holes 42, whereby the core member 12 is produced (FIG. 4). On the other hand, the diameter of the seal region 18 of the elastic tube member 16 is expanded fully using an appropriate tool. The core member 12 is then inserted into the expanded seal region 18 to such an extent that the projecting region 38a of the internal-layer portion 38 of the sliding member 34 is exposed to outside from the opening end 14. Expanding the diameter of the seal region 18 is then stopped. Consequently, the core member 12 is inserted in the seal region 18 with the sliding member 34, which is folded in two, interposed between the body 22 and the seal region 18 of the elastic tube member 16 (FIG. 3).

Referring to FIG. 8, a process of attaching the cold shrink tube unit 10 to the object of covering P will be described. The object of covering (for example, a cable) P is passed through the cold shrink tube unit 10 that is in the state shown in FIG. 1. The cold shrink tube unit 10 is positioned so that the intermediate region 20 of the elastic tube member 16 will cover a desired portion Q of the object P (for example, an electric joint). In this ready state, a large enough gap is created between the elastic tube member 16 or the pair of core members 12, which are included in the cold shrink tube unit 10, and the object of covering P (FIG. 8(a)).

In the ready state, a remotely controlled instrument that is not shown is used to hook the arc portion 26b of the extension 26 of one of the core members 12. Thus, external force (tensile force) is applied in the direction of arrow a in the drawing. The tensile force α is efficiently transmitted to the body 22 via the extension 26. Consequently, the body 22 is pulled out from the seal region 18 of the elastic tube member 16. Meanwhile, the internal-layer portion 38 of the sliding member 34 forming the sliding material 24 which is locked by the fitting claws 44 formed on the body 22 is pulled out of the seal region 18 together with the body 22 (FIG. 8(b)). On the other hand, the external-layer portion 40 of the sliding member 34 is brought into close contact with the internal surface of the seal region 18 with frictional force larger than the property of sliding on the internal-layer portion 38 (that is, reduced frictional force). Consequently, the internal-layer portion 38 and external-layer portion 40 of the sliding member 34 make relative movements while sliding on each other. At the same time, the external-layer portion 40 is gradually pulled into the internal-layer portion 38 relative to the crease 36, and thus gradually shifts to a developed state (FIG. 7(a)).

Tensile force α is kept applied to the extension 26. Eventually, the body 22 is fully pulled out of the seal region 18 of the elastic tube member 16 due to the self-sliding property of the sliding member 34. Accordingly, the developed sliding member 34 is taken out of the seal region 18. Thus, the core member 12 is detached from the associated seal region 18, and the seal region 18 is attached closely to the outer peripheral surface of the object of covering P owing to the elastically restoring force. The same work is performed on the other core member 12. Consequently, the elastic tube member 18 is properly attached to the object of covering P.

As apparent from the above description, as far as the core member 12 employed in the embodiment of the present invention is concerned, external force required to detach the core member 12 from the elastic tube such as the seal region 18 of the elastic tube member 16 can be efficiently applied directly to the body 22 via the extension 26 formed on the body 22. The mechanical strength of the extension 26 that is large enough to withstand detaching force is provided by the extension 26 itself and the region coupling the extension 26 with the body 22. Consequently, unlike conventional structures in which detaching force is applied to a sliding member, an optimal material that exhibits a sliding property and a smoothly moving property which are required for detachment of the core member can be selected for use. According to the core member 12, external force required to detach the body 22 from the elastic tube can be efficiently transmitted to the body 22. The work of detaching the core member can be quickly achieved in a stable manner with high reliability.

Moreover, when the cold shrink tube unit 10 in accordance with the embodiment of the present invention having the core member 12 is attached to an object of covering, even if the core member 12 must be detached outdoor using a remotely-controlled instrument, external force required for detachment can be efficiently applied to the body 22 of the core member 12. Consequently, the workability in attaching the cold shrink tube unit to the object of covering markedly improves. In the attachment work, the core member 12 can be quickly removed from the seal region 18 of the elastic tube member 16 with small tensile force owing to the excellent self-sliding property of the sliding member 34. Consequently, the elastic tube member 16 can be easily attached to the object of covering.

The preferred embodiment of the present invention has been described so far. Noted is that the present invention is not limited to the illustrated structure of the embodiment but various modifications and changes can be made within the scope of the invention defined with Claims.

For example, the extension 26 of the core member 12 may be, as shown in FIG. 9, included in each of the plate-like elements 28 constituting the body 22. In this structure, the body 22 can be formed with a pair of plate-like elements 28 that are independent of each other, that is, completely separated from each other. In this case, an extension 26 having one arm portion 26a and one arc portion 26b is included in each of the plate-like elements 28 (FIG. 9(a)). Otherwise, the body 22 can be formed with a pair of plate-like elements 28 that is joined so that they can hinge on each other via another coupling portion 50. In this case, at least one of the plate-like elements 28 includes the similar extension 26 (FIG. 9(b)).

Moreover, the body 22 of the core member 12 is not limited to the illustrated hollow cylinder but may be formed as a hollow cylindrical body shaped like a polygonal prism. When the polygonal prism structure is adopted, the structure of a die becomes simpler and the rigidity of the core member 12 improves. Furthermore, the body 22 of the core member 12 is not limited to the structure having the plate-like elements 28 that are equivalent to halves of a hollow cylindrical body. Otherwise, the body 22 may adopt a structure having plate-like elements 28 formed by dividing a hollow cylinder into three or more portions, or a structure having the hollow cylinder undivided.

Moreover, as the constituent feature for locking the sliding member 34 at a predetermined position on the outer peripheral surface 22c of the body 22, instead of or in addition to the attachment holes 42 and fitting claws 44, a pressure-sensitive adhesive double coated tape or an adhesive may be employed or thermal fusion may be adopted. Furthermore, the body and sliding member 34 may be integrated into one unit. Moreover, as the constituent feature for preventing the spontaneous detachment of the core member 12 when the cold shrink tube unit 10 is constructed prior to use, instead of or in addition to the cutouts 46 of the sliding member 34, the elastic tube member 16 and core member 12 may be temporarily joined using an adhesive tape or a mechanical coupling structure. Furthermore, in the core member 12 employed in the present invention, a lubricant such as a silicone grease or silica may be substituted for the sliding material 24 formed with the sliding member 34.

The structure of the slidingly detachable core member in accordance with the present invention can be adapted to a cold shrink tube unit having a core member inserted in an elastic tube member over the whole length of the elastic tube member. The present invention can be adapted to a cold shrink tube unit shaped like a branch pipe. The present invention can also be adapted to a cold shrink tube unit in which a hollow cylindrical internal-layer element made of an elastomer whose property is different from that of the material made into the elastic tube member is inserted in a seal region of the elastic tube member on a fixed basis in order to improve the sealing property of the seal region of the elastic tube member.

1. A slidingly detachable core member for use within an elastic tube, comprising a hollow cylindrical body and a sliding material associated with said body for reducing friction between said body and an elastic tube encompassing said body, characterized in that:
an extension is provided in said body and extends outward, to transmit external force, for detachment of said body from the elastic tube, to said body.

2. A slidingly detachable core member according to claim 1, wherein said sliding material includes a sheet-like sliding member arranged on an outer peripheral surface of said body.

3. A slidingly detachable core member according to claim 2, wherein said sliding member is formed separately from said body and attached to said body.

4. A slidingly detachable core member according to claim 2, wherein said sliding member comprises a molded film with self-sliding property arranged to be folded on said outer peripheral surface of said body in a condition where said body is placed in an operable position to be encompassed within the elastic tube; said molded film being shaped to substantially cover a working region, encompassed within the elastic tube, in said outer peripheral surface of said body placed in said operable position.

5. A slidingly detachable core member according to claim 4, wherein said molded film includes cutouts for locally exposing said working region of said outer peripheral surface of said body.

6. A slidingly detachable core member according to claim 1, wherein said body includes a plurality of plate-like elements assembled together to form a hollow cylindrical body, and wherein said extension has flexibility in itself and joins said plate-like elements shiftably relative to each other.

7. A cold shrink tube unit comprising an elastic tube member having an opening end, and a hollow cylindrical core member detachably arranged within a seal region of said elastic tube member defined in a predetermined length from said opening end to hold said seal region in an elastically expanding state, characterized in that:
said core member is comprised of a slidingly detachable core member according to claim 1; and
said slidingly detachable core member is arranged to be encompassed within said seal region with said extension projecting outward from said opening end of said elastic tube member.
